(19) United States
(12) Patent Application Publication
(10) Pub. No.: US 2025/0131379 A1
(43) Pub. Date: Apr. 24, 2025

(54) COMPREHENSIVE SERVICE AND PROJECT MANAGEMENT SYSTEM

(71) Applicant: Purple Collar Technology LLC, Middletown, DE (US)

(72) Inventor: Phil ROGACKI, Bay Point, CA (US)

(21) Appl. No.: 18/920,641

(22) Filed: Oct. 18, 2024

Related U.S. Application Data
(60) Provisional application No. 63/544,680, filed on Oct. 18, 2023.

(51) Int. Cl. G06Q 10/10; G06Q 30/04

(52) U.S. Cl. CPC G06Q 10/103; G06Q 30/04

(57) ABSTRACT

A method for performing project management that comprises: generating, by a processor, a draft proposal of a project; sending, by the processor, the draft proposal to a client device to be reviewed by a client; receiving, by the processor, a client input on the draft proposal from the client device; for the client input indicating client approval of the draft proposal, initiating, by the processor, work scheduling with the client.

### CROSS-REFERENCE TO RELATED APPLICATIONS

This application claims priority under 35 USC § 119(e) to U.S. Provisional Application No. 63/544,680, filed on Oct. 18, 2023, the contents of which are incorporated herein by reference in their entirety.

### BACKGROUND

### Field

The present invention generally relates to systems and methods for project management between clients and service providers. Specifically, utilizing a single management application to facilitate the management of construction-related projects.

### Related Art

Construction applications or apps are well known in the industry, and provide a wide array of services to clients and business providers. There are dozens of construction apps to choose from, ranging from free, single-feature apps to paid complex apps for teams and large companies. These applications can be beneficial for architects, contractors, and customers.

In the related art, various construction applications help construction workers and construction companies to manage projects from remote locations. They are designed to automate tasks, store and share documents, upload plans, manage tasks, and more. However, multiple apps may be required to provide a full service to the customer and business operator. Further, these apps may not be compatible with each other and may require the user to manage different apps for the same project.

In view of the above, what is desired is a single application capable of complete project management and customer service.

### SUMMARY

Example implementations provide multi-tenant system applications for providing workflow to salespeople, workers, and clients, while communicating the information with other software services.

A sales user visits the client's project location and performs a concrete inventory using the project management app. The user can walk through the location and drop pins on the map precisely where the project is located, e.g., where the concrete is located. This map pin represents a project/repair area in the system. The user can take pictures of the pinned areas, followed by setting the concrete type and concrete size, e.g., cubic or square feet. In addition, inventory treatment items can be added to the concrete. Treatment prices may be modified if needed. Prices are calculated by multiplying the concrete size (width×length→Ft² or width×length× height→Ft³) with a base price multiplier.

After the inventory work is completed, the user can sync all the concrete inventory made. The app can batch upload the images and concrete information to a server. The sales user can create a draft proposal (proposal status=draft) and start adding a subset of concrete to it. Each concrete inventory treatment items can be added to the proposal. These proposal treatment items might include different prices and might include an absolutely different set of treatments compared to the inventory treatment items.

After all required concretes and services are added to a proposal, the sales user can do a job plan. The job plan can help to determine the possible profit and work effort by setting labor, equipment, or materials required for the job (expected costs). The location may have many proposals with different statuses. Every proposal can have item arrays which have treatments in them. Every treatment has a concrete ID in it, which points to the concrete on the location. Additionally, other import values include item ID, price, and treatment ID. When the draft proposal and job plan are ready, the user can send them to the client using the app or the web version of the app. After being sent, the customer receives a proposal PDF. The application allows back and forward communication between the client and the user. This includes negotiations that may affect the proposal and price.

If the customer agrees and sends a signed proposal via PDF within the app, then the sales user can set the proposal status to approved. After the approved proposal, the work can be scheduled into the service provider's calendar. The status will become scheduled. When the job start date arrives, the designated work crew will go out to the location and start working on the concrete treatment items. Before the working crew start working, they have to clock-in using T-Sheets integrated with the project management app. Time spent by workers creating proposals is also tracked by the project management app.

Every proposal treatment can be marked as completed/uncompleted. The proposal's status changes to “in progress” as soon as the first treatment or service is initiated. If all treatments and miscellaneous services are completed, then the work status can be marked as completed (status=completed). After that, an invoice can be sent to the customer (status=Invoiced). After the client pays the invoice, the status becomes “paid” and the business cycle comes to an end.

Accordingly, one aspect of the present disclosure is a method for performing project management comprising the steps of generating, by a processor, a draft proposal of a project; sending, by the processor, the draft proposal to a client device to be reviewed by a client; receiving, by the processor, a client input on the draft proposal from the client device; and for the client input indicating client approval of the draft proposal, initiating, by the processor, work scheduling with the client.

In another aspect of the present disclosure, the method further comprises, for the client input indicating client rejection or modification of the draft proposal: incrementing, by the processor, an iteration counter by a value of one; determining, by the processor, whether a value of the iteration counter is equal to an iteration threshold; and for the value of the iteration counter being determined as equal to the iteration threshold, terminating, by the processor, proposal drafting of the project.

In another aspect of the present disclosure, the method further comprises, for the value of the iteration counter being determined as less than the iteration threshold, updating, by the processor, the draft proposal to generate an updated draft proposal of the project; sending, by the processor, the updated draft proposal to the client device to be reviewed by the client; receiving, by the processor, a second client input on the updated draft proposal from the client device; and for the second client input indicating client approval of the updated draft proposal, initiating, by the processor, work scheduling with the client.

In another aspect of the present disclosure, the method further comprises, for the second client input indicating client rejection or modification of the updated draft proposal: incrementing, by the processor, the iteration counter by a value of one; determining, by the processor, whether the value of the iteration counter is equal to the iteration threshold; for the value of the iteration counter being determined as equal to the iteration threshold, terminating, by the processor, proposal drafting of the project; and for the value of the iteration counter being determined as less than the iteration threshold, reinitiating update on the updated draft proposal for the client to review.

In another aspect of the present disclosure, the method further comprises receiving, by the processor, status update on at least one task associated with the draft proposal after (i) receiving the client input indicating approval of the draft proposal; and (ii) the at least one task has been initiated.

In another aspect of the present disclosure, the method further comprises, for a completion status being received for the at least one task, issuing, by the processor, an invoice associated with the at least one task to the client.

In another aspect of the present disclosure, the method further comprises, receiving, by the processor, project information comprising one or more of location information, project type, or image data.

In another aspect of the present disclosure, the method further comprises generating the draft proposal is performed using an Artificial Intelligence (AI) model, wherein the AI model receives project information as input and generates the draft proposal as output.

One aspect of the present disclosure is a non-transitory computer readable medium, storing instructions for performing project management. The instructions comprising the steps of generating a draft proposal of a project; sending the draft proposal to a client device to be reviewed by a client; receiving a client input on the draft proposal from the client device; and for the client input indicating client approval of the draft proposal, initiating work scheduling with the client.

### BRIEF DESCRIPTION OF DRAWINGS

A general architecture that implements the various features of the disclosure will now be described with reference to the drawings. The drawings and the associated descriptions are provided to illustrate example implementations of the disclosure and not to limit the scope of the disclosure. Throughout the drawings, reference numbers are reused to indicate correspondence between referenced elements.

FIG. 1 illustrates an example process flow for work order processing utilizing the project management application, in accordance with an example implementation.

FIG. 2 illustrates an example process flow for work order coordination and management, in accordance with an example implementation.

FIG. 3 illustrates an example management system, in accordance with an example implementation.

FIG. 4 illustrates an example app layout on a display device, in accordance with an example implementation.

FIG. 5 illustrates an example pin utilizing the conventional Hit-Rect Detection algorithm.

FIG. 6 illustrates two overlapping pins utilizing the conventional Hit-Rect Detection algorithm.

FIG. 7 illustrates human interaction with the two overlapping pins of FIG. 6.

FIG. 8 illustrates distances from pins' center points to pointed location on the digital map of FIG. 7.

FIG. 9 illustrates an example object searching method, in accordance with an example implementation.

FIG. 10(a)-(d) illustrates example search sequences utilizing the object searching method of FIG. 9, in accordance with an example implementation.

FIG. 11 illustrates an example digital map in the application with dropped pins representing work locations, in accordance with an example implementation.

FIG. 12 illustrates an example project information display showing images taken and concrete dimensions, in accordance with an example implementation.

FIG. 13 illustrates an example application display providing cost forecasting, in accordance with an example implementation.

FIG. 14 illustrates an example application display providing cost forecasting using provided dimensions, in accordance with an example implementation.

FIG. 15 illustrates an example application display showing a completed task that has been checked off, in accordance with an example implementation.

FIG. 16 illustrates an example computing environment with an example computing device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination, and the functionality of the example implementations can be implemented through any means according to the desired implementations.

The use of smartphones and computer applications has become a necessity for commercial purposes. Current construction apps allow construction workers and construction company owners to download the apps on their smartphones or tablets for use. The apps are designed to automate tasks, store and share documents, upload plans, manage tasks, etc. However, use of multiple apps may be required to provide full service to customers and business operators. In addition, these apps may not be compatible with each other and may require the user to manage different apps for the same project.

Currently, apps that focus on construction managing projects do not provide a full service. A full-service application allows the provider and client to manage the project from beginning to end. This means that service providers can initiate a request, provide an estimate of the costs, and allocate the assets needed to complete a project for the client. From the client's perspective, features such as proposal acceptance and project progress monitoring are examples of what a full-service construction application constitutes.

Example implementations provide a sole application for managing construction-related projects and customer service. The application allows mobile and web server access for clients and project managers, and mitigates the problem of sorting a project through different apps. The use of multiple apps often results in confusion for clients, and inefficient management practice for service providers. Therefore, a centralized data source solves the need to rely on external data management systems that can result in miscommunication or mismanaged projects.

Another object of the example implementations is to provide an application that specializes in concrete cutting and repair projects. The present invention is focused on, but not limited to, concrete repair projects where measurements and estimates may be accomplished without being physically at the work site. This means that clients can do the surveillance part without having the service provider on site to provide initial assessment.

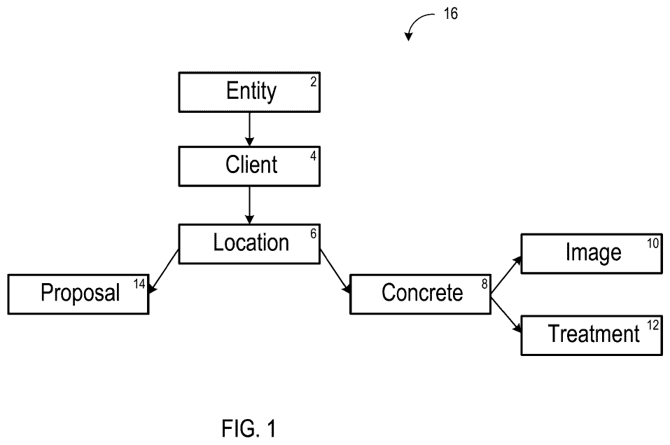

FIG. 1 illustrates an example process flow 16 for processing work order utilizing the project management application, in accordance with an example implementation. Process flow 16 allows the user or users of the application to complete and manage a project from beginning to end, without the need of an external/third-party service. This means that the entirety of the project is controlled through the features of the application via mobile devices or web server.

As illustrated in FIG. 1, the process flow 16 begins with a work order initiated by an entity (sales user) 2, who communicates with the client 4 to obtain information about the project to be performed. The entity 2 refers to the organization representative, sales representative, or project manager who is responsible for the order. The work order can be initiated through the application or web server by the service provider. In some alternate implementations, the client 4 can initiate a request to alert the service provider that a new service is being requested instead of entity 2. Through initiation of the work order by the client 4, the entity 2 can establish communication with the client 4 to receive information regarding the project of client 4.

Further, client 4 provides a location 6 where the job will be performed. This allows the service provider to know exactly where the job is located and decide if the location 6 is within the allowable service range. By providing the location 6, the service provider can assess the area to determine any risks, environmental concerns, or compliance issues with local authorities. At the same time, location provision allows for assessment of area prices and provides an accurate estimation of the prices for that specific region.

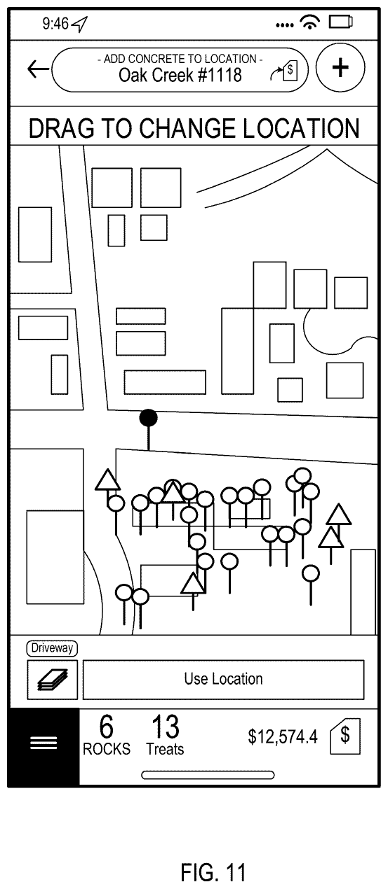

After the location 6 is shared, the entity 2 then can walk through location 6 and drop pins on a digital map in the app to identify the areas where the work will be performed. FIG. 11 illustrates an example digital map in the application with dropped pins representing work locations, in accordance with an example implementation. By delineating the work area, the service provider can accurately locate where the work will be performed. This process removes the need to revisit the work area and mitigates the single-point failure of changes in personnel. Additionally, the information can be accessed by other members of the team who may need to have visuals to perform any additional operations. These operations may include, but are not limited to, estimates, proposals, before-and-after examples, data gathering, etc.

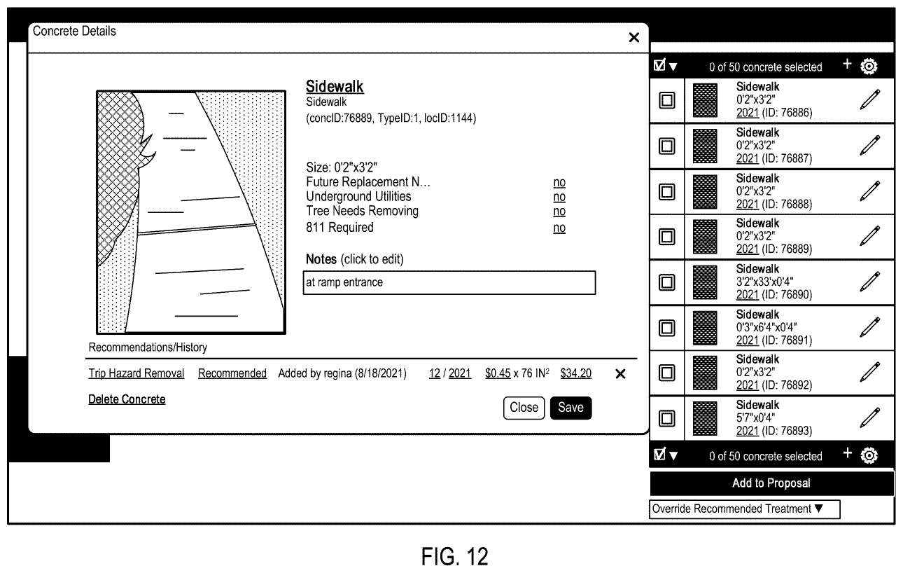

Furthermore, the dropped pin represents the areas where repairs are needed. These areas are known as concrete 8. The entity 2 can take images 10 to set the concrete type and concrete size of the designated repairs (cubic or square size). FIG. 12 illustrates an example project information display showing images taken and concrete dimensions, in accordance with an example implementation. Additionally, the entity 2 can add treatment 12 to the concrete 8 to specify any special features to be added into the repair area. These features can be modified if needed, which can change the prices for each feature.

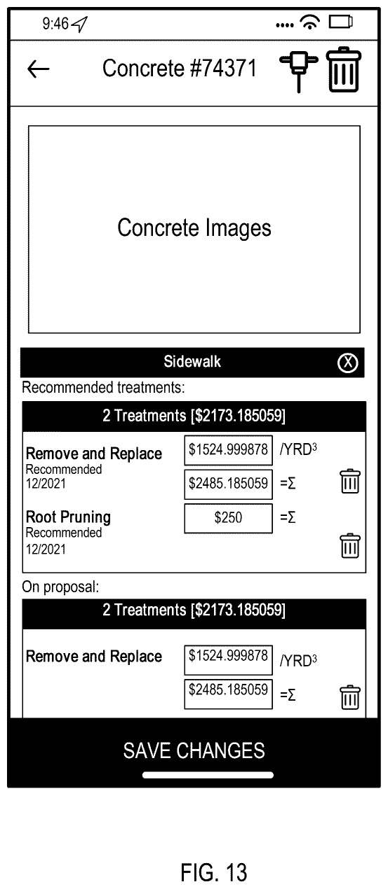

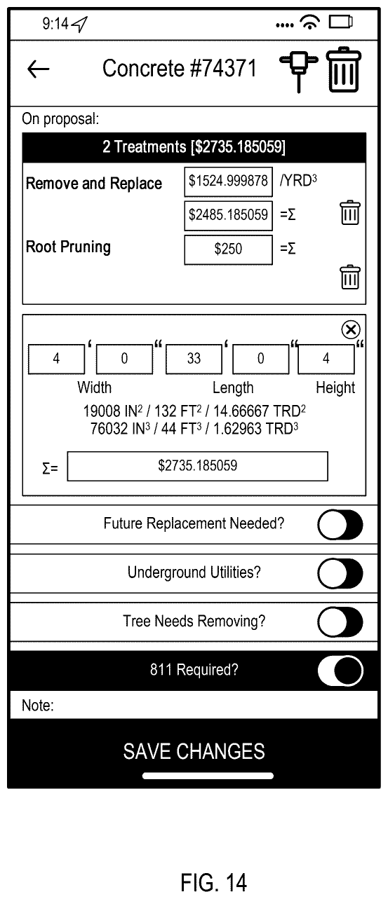

The application allows the calculation of prices according to the type of concrete and treatments used. The concrete and treatment types have allocated prices that allow the user to mix and match the combinations to provide a forecast of the costs. Prices are calculated by multiplying the size (W×L→Ft² or W×L×H→Ft³) with a base price. FIG. 13 illustrates an example application display providing cost forecasting, in accordance with an example implementation. FIG. 14 illustrates an example application display providing cost forecasting using provided dimensions, in accordance with an example implementation. Miscellaneous costs may be added to the equation, depending on the service needs.

After all the features of the work order are completed, the entity 2 can move to create a proposal 14 for the client 4. The proposal 14 includes a list of the selected items that need to be added for completing the work. The client 4 has access to the proposal 14 via app to ensure that the items are accurate. These items may be changed or deleted by either the client 4 or the entity 2 creating the proposal 14. All the communication and changes can be done through the app or web server to provide real-time updates of the proposal until a final decision is made. A final inventory of the proposal details then is created.

After inventory work is done the user can sync all the repair inventory into a single work order. The work order includes the itemized details and expected labor costs. This allows other parties involved, such as the foreman and crew members, to access the work details. By having access, the parties involved can receive updates to the needs of the client 4. This feature facilitates the communication among all the parties.

Additionally, the app will batch upload the images 10 and information of concrete 8 to a designated server. The visual information provides additional information for all users and ensures that everyone has the same information of the worksite.

In some example implementations, client 4 may initiate the work order instead of entity 2. Specifically, client 4 may provide project information by inputting the information directly into the application. Project information include information such as, but not limited to, location 6 (location information), concrete 8 (project type), image 10 (image data), etc. The entity 2 then provides proposals based on the provided information for client 4 to review.

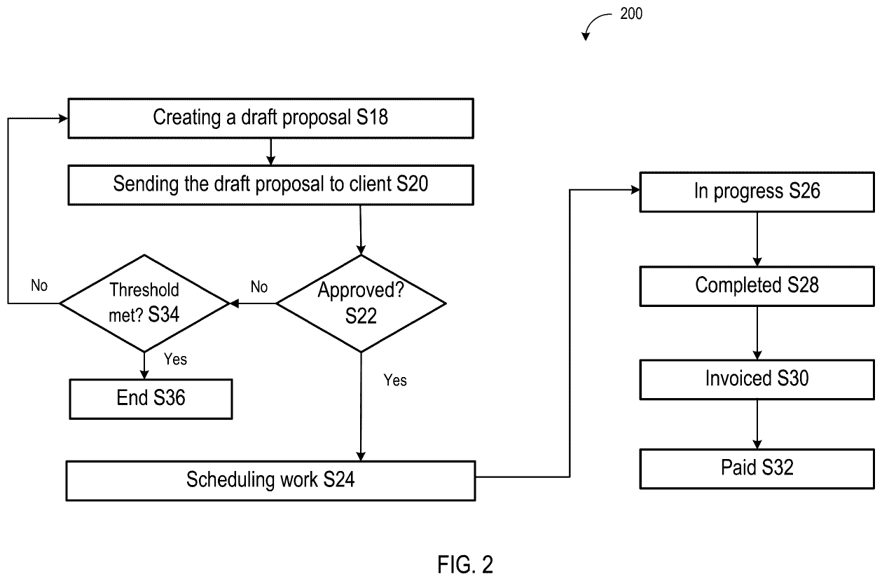

FIG. 2 illustrates an example process flow 200 for work order coordination and management, in accordance with an example implementation. The process flow 200 contains the steps needed to accomplish the methods directed to coordination and management of work orders. The process begins with S18, where a draft proposal is created by the entity 2. As with FIG. 1, the process flow 200 can be completed through a mobile application and/or a web server.

At S18, the draft proposal is generated from the received work order details, including information such as, but not limited to, concrete 8, treatments 12, etc. The draft proposal may include prices associated with the original work order and prices associated with inventory addition work options. In some example implementations, the draft proposal may include a work plan generated by the sales user to help determine the possible profits and expected costs as calculated through estimated workforce, equipment, and materials required for the work order.

After completion of S18, the process then proceeds to S20, where the draft proposal is sent to the client 4 through the application or web version for review on a user device. Examples of user device may include, but not limited to mobile devices (e.g., smartphones, devices in vehicle and other machine, tablets, notebooks, laptops, personal computers, etc.), and devices not designed for mobility (e.g., desktop computers, information kiosks, televisions, etc.). At this stage, the work order status becomes “sent.” At S22, client 4 reviews and makes the determination to whether approve the proposed draft or not. Prices associated with the work order may change should client 4 decide to make changes to the proposed draft. If the proposed draft is approved at S22, the order status will change to “approved” and the process continues to step S24. Client 4 may provide additional notes to an approved proposal, such notes may include additional information such as, but not limited to, presence of a dog on premises, parking payment, etc. If any additional changes are made by client 4 (modification) or if the draft proposal is rejected by client 4, then it is determined that the proposed draft is not approved at S22, and the process proceeds to step S34.

At S34, a determination is made as to whether a threshold number of proposal iterations has been reached. A counter is used to track the number of review iterations. Every time a proposal or a revised/updated proposal is sent to client 4 for approval, the counter is increased by one. The counter number is then compared against a threshold to determine whether the threshold number of reviews is met. If the threshold is met at S34, then the process continues to S36, where the process comes to an end for failure to reach an agreement between the parties. If the threshold is not met at S34, then the process returns to S18, where the draft proposal is updated or a new draft proposal is generated. In some example implementations, generating and updating of the draft proposal may be performed by either the entity 2, an Artificial Intelligence (AI) model, or both. The AI model may include, but not limited to, recurrent neural network (RNN), deep RNN (DRNN), Q-learning network (QN), deep Q-learning network (DQN), etc. RNN may include long short-term memory (LSTM), etc. In some example implementations, the AI model is a large multimodal language model that works with different types of input data, such as text, images, audio, video, etc. The AI module is iteratively trained using historical data/past proposals as training input and training parameters are adjusted to generate optimal results/proposals.

In some example implementations, the threshold at S34 is a time threshold. For example, the threshold may be a time period of two months. If client 4 does not approve the proposal at step S22 and fails to respond within the time threshold, then the process comes to an end at S36, where the project is closed and archived. The time threshold may be adjusted on project-by-project basis.

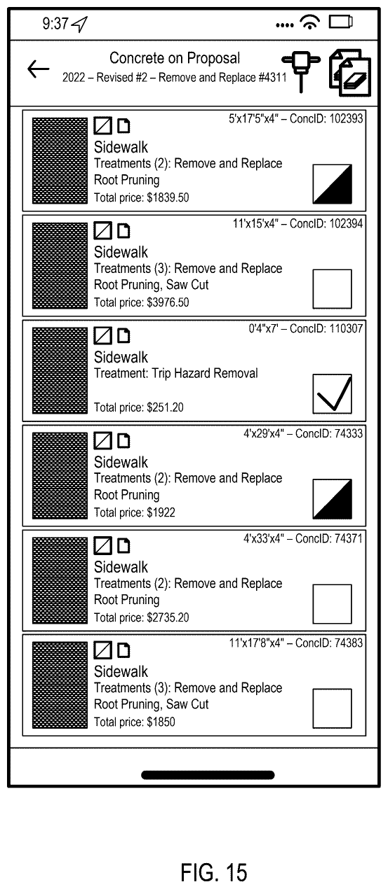

Next, work is scheduled at S24 and the crew arrives at the work site on the scheduled day. Before the crew starts working, they can clock-in using the app (via timesheets) and record the hours spent on the project. As soon as work is started on a project or when a task among a number of tasks associated with a project is completed, the status of the project is marked as “In progress” at S26. Whenever a task is completed, the task is checked off on the application to indicate task completion. FIG. 15 illustrates an example application display showing a completed task that has been checked off, in accordance with an example implementation. Tasks under different statuses are assigned with different indicators, such indicators may include, but not limited to, checked box for task completion, unchecked box for a task that has yet to begin, etc. If a project under the “in progress” state is completed, then the project is marked as “completed” at S28. In some example implementations, images of completed tasks or projects are taken and uploaded for status monitoring and accessible by client 4 to review. Finally, when the work is completed 28, the final price is invoiced to the client 4 and the status changes to “invoiced” at step S30. At S32, the invoice is paid by the client, and the project is completed.

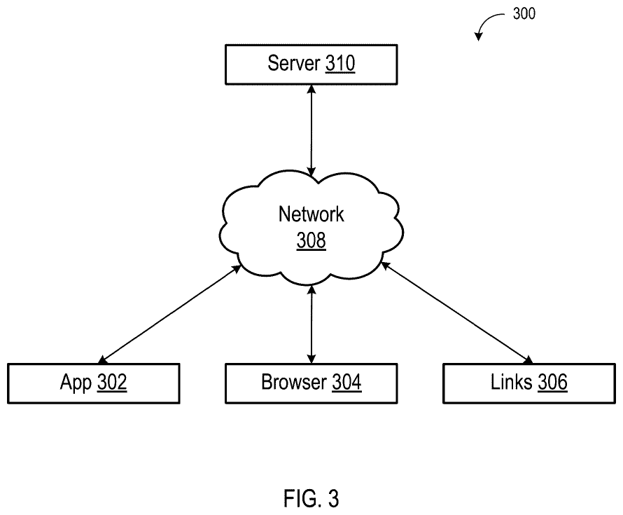

FIG. 3 illustrates an example management system 300, in accordance with an example implementation. As illustrated in FIG. 3, the management system 300 may include app 302, browser 304, links 306, network 308, and server 310. App 302, browser 304, and links 306 are communicatively coupled to network 308, which is connected to the server 310. Network 308 can be any network or combination of networks (e.g., internet, local area network, wide area network, telephonic network, cellular network, satellite network, etc.). The server 310 manages a database, which contains data aggregated from the app 302, browser 304, and links 306.

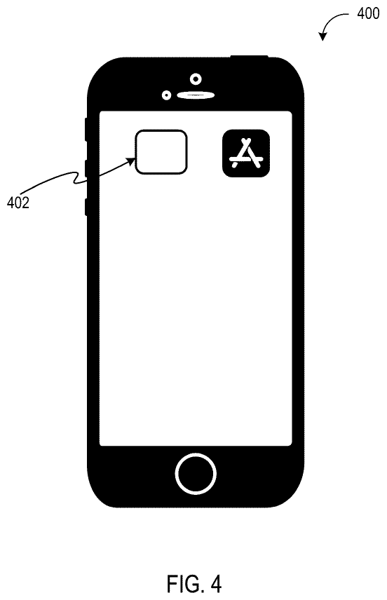

FIG. 4 illustrates an example app layout on a display device 400, in accordance with an example implementation. The display device 400 may display icons representing different applications capable of operating on the display device 400. In some example implementations, icon 402 shows how the project management app is displayed on the display device 400.

The foregoing example implementation may have various benefits and advantages. For example, allowing service provider and client to manage a project from beginning to end on a single full-service application without the inconvenience of using multiple applications. In addition, use of a centralized data source solves the need to rely on external data management systems that can result in miscommunication or mismanaged projects.

Although the present disclosure describes aspects and/or embodiments with reference to concrete projects/works, the aspects and/or embodiments are not limited to or confined to concrete projects/works. For example, aspects aid/or embodiments as described can be applied to projects/works in other fields and practices (e.g. carpentry, yardwork, etc.)

Object Selection Associated with Dropped Pins

An object selection program is a computer implemented software algorithm for selecting a Point of Interest (POI) object, represented by a pin on a digital map that is displayed on a device which is capable of accepting user inputs in the form of pointing or tapping on the digital map. Example implementations relate to a novel technique for selecting an object out of closely clustered objects. The objects may represent, but are not limited to, concrete slabs, trees, and other objects known to be displayed on a digital map in clusters.

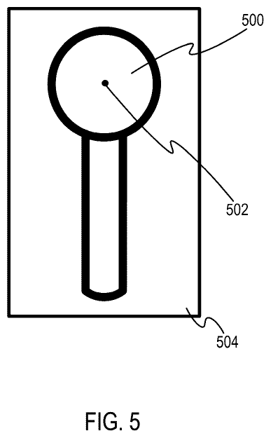

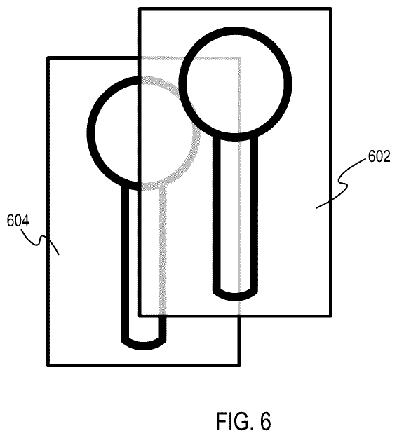

The conventional method of object selection on a display involves application of Hit-Rect Detection, which is utilized to identify which pin was most likely selected by the user. FIG. 5 illustrates an example pin 500 utilizing the conventional Hit-Rect Detection algorithm. Every pin has a center point 502, which represents the geographic coordinates on the digital map. A pin 500 is surrounded with a Hit-Rect 504. A pin is selected if the user input was pointed inside the Hit-Rect 504. FIG. 6 illustrates two overlapping pins utilizing the conventional Hit-Rect Detection algorithm. As illustrated in FIG. 6, multiple Hit-Rects 602 and 604 may overlap on top of each other. The software developer decides in which order (Z-order) the pins are added to the digital map.

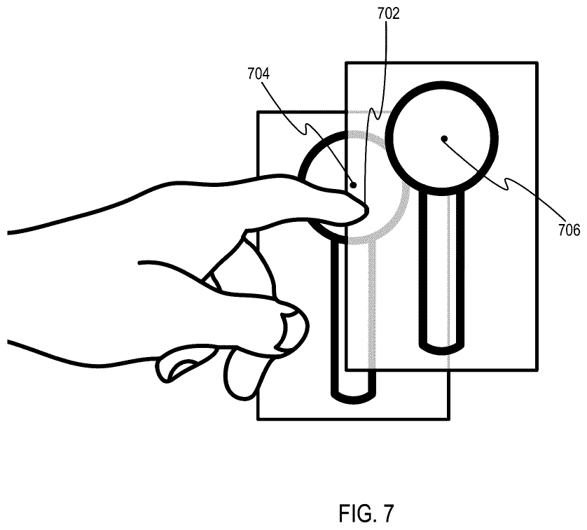

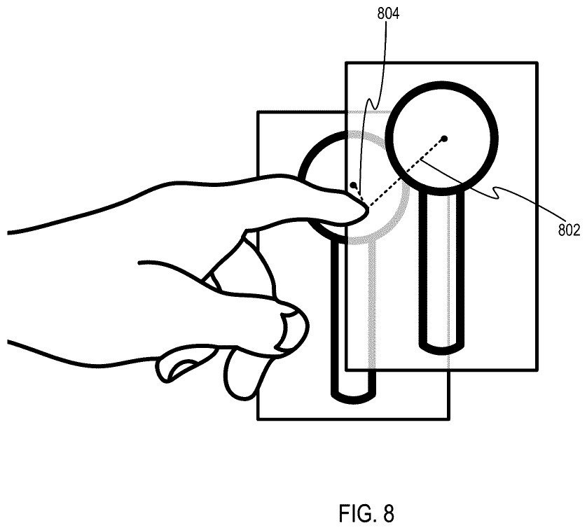

FIG. 7 illustrates human interaction with the two overlapping pins of FIG. 6. The problems with the conventional Hit-Rect Detection algorithms are special use cases of user pointing (clicking, touching, or any other forms of pointing methods) 702 to a location inside two or more overlapping Hit-Rects. In those cases, only the topmost visible pin will be selected since only the topmost Hit-Rect gets validated. As illustrated in FIG. 7, this often results in the wrong pin, pin 706, being selected instead of the desired pin, pin 704, which has the shorter of distances from the pins' center points and the pointed location, distance 804 of FIG. 8. FIG. 8 illustrates distances from pins' center points to pointed location on the digital map of FIG. 7. Distance 802 represents the distance from the top layer pin's center point to the pointed location, and distance 804 represents the distance from the bottom layer pin's center point to the pointed location. This problem aggravates as soon as more pins are layered and displayed on top of each other.

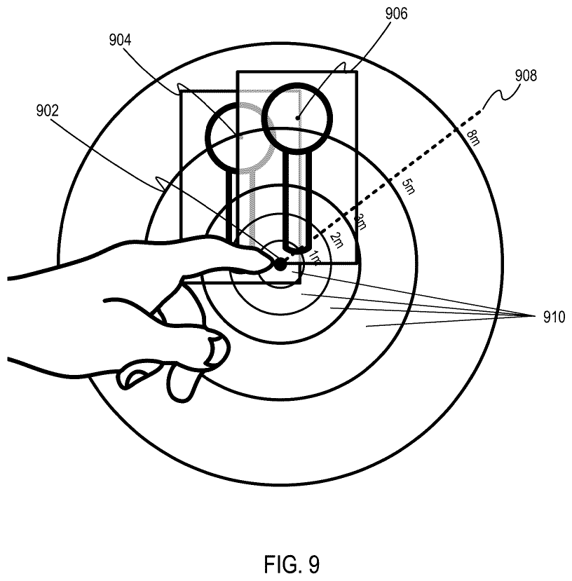

Example implementations find and select the nearest pin to the pointed location without the use of conventional Hit-Rect Detection algorithms which results in the selection of the wrong pins. FIG. 9 illustrates an example object searching method, in accordance with an example implementation. Location 902 is a coordinate where a user points to a digital map to initiate search. Location 904 represents the bottom pin's center point between the 3-5 m radius. Location 906 represents the top pin's center point between the 5-8 m radius. The method first utilizes a Fibonacci search technique (divide and conquer) with 30 iterations. Radiuses 908 represent the search radiuses according to the Fibonacci sequence. Regions 910 represent search regions between search radiuses. In some example implementations, the number of iterations may be adjusted according to user/operator preference. If the number of iterations is reduced, then required processing power/resources can also be reduced. In between iterations, Quick Search is utilized to find the pin with the shortest distance.

The sequence to determine the search range radiuses is defined using Fibonacci numbers. Taking 30 iterations as example:

$$F 0 = 0 ,$$

$$F 1 = 1$$

$$and$$

$$Fn = Fn - 1 + F n - 2 ( for n > 1 and n <= 30 )$$

This results in a sequence of 30 numbers: 1, 2, 3, 5, 8, 13 . . . and 832040. The complexity of this algorithm is O(log n) where n is the number of pins.

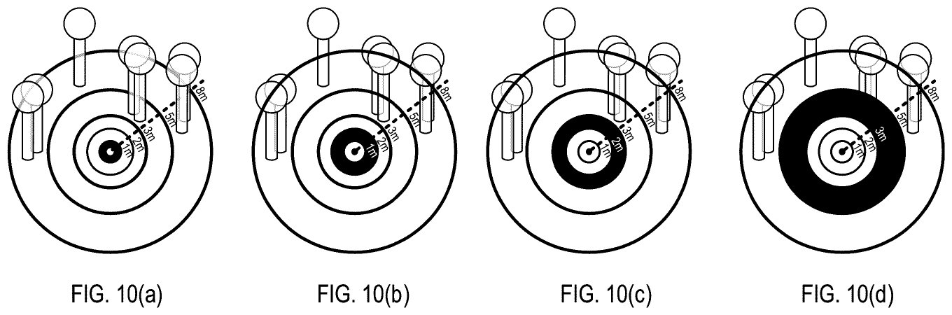

FIG. 10(a)-(d) illustrates example search sequences utilizing the object searching method of FIG. 9, in accordance with an example implementation. At the first iteration, illustrated by FIG. 10(a), the algorithm is only searching for pins that are within a first search range of 1-meter circular radius from a touch center. The search process may be initiated through user's direct input/interaction with a user device (e.g. contacting a display of the user device, holding a finger for a prolonged period on an area of the display of the user device, etc.). Examples of user device may include, but not be limited to mobile devices (e.g., smartphones, devices in vehicle and other machine, tablets, notebooks, laptops, personal computers, etc.), and devices not designed for mobility (e.g., desktop computers, information kiosks, televisions, etc.). If no potential pins are found, then it continues searching for pins between 1-2 m search range from the touch center, as illustrated in FIG. 10(b). This is then followed by a search range of 2-3 m from the touch center, as illustrated in FIG. 10(c). The process continues to the search range of 3-5 m from the touch center as illustrated in FIG. 10(d) and so on (Fibonacci sequence of radiuses). The algorithm comes to a stop whenever one of the following conditions occurs:
1. If the search does not find any potential pins in the last search range;
2. If the search hits the maximum search radius limit, e.g. 1/11^{th} of the map display width; or
3. If the search hits the maximum search radius limit of 832040 meters, which is the limit to 30 iterations of searching.

As illustrated in FIG. 10(d), if one or more pins are found within a search range, then the algorithm continues searching for one single nearest pin. Linear searching algorithm is applied to find the pin with the shortest distance to the pointed location.

The foregoing example implementation may have various benefits and advantages, for example, improved user experience and reduced object selection errors when interacting with a digital map that has over-cluttered pins and other PoI objects stacking up on top of each other.

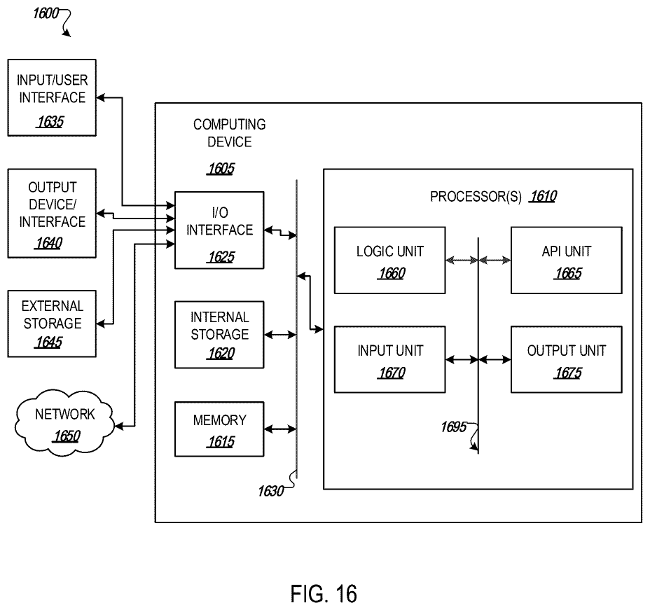

FIG. 16 illustrates an example computing environment with an example computer device suitable for use in some example implementations. Computer device 1605 in computing environment 1600 can include one or more processing units, cores, or processors 1610, memory 1615 (e.g., RAM, ROM, and/or the like), internal storage 1620 (e.g., magnetic, optical, solid-state storage, and/or organic), and/or IO interface 1625, any of which can be coupled on a communication mechanism or bus 1630 for communicating information or embedded in the computer device 1605. IO interface 1625 is also configured to receive images from cameras or provide images to projectors or displays, depending on the desired implementation.

Computer device 1605 can be communicatively coupled to input/user interface 1235 and output device/interface 1240. Either one or both of the input/user interface 1235 and output device/interface 1240 can be a wired or wireless interface and can be detachable. Input/user interface 1235 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 1240 may include a display, television, monitor, printer, speaker, braille, or the like. In some example implementations, input/user interface 1235 and output device/interface 1240 can be embedded with or physically coupled to the computer device 1605. In other example implementations, other computer devices may function as or provide the functions of input/user interface 1235 and output device/interface 1240 for a computer device 1605.

Examples of computer device 1605 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1605 can be communicatively coupled (e.g., via IO interface 1625) to external storage 1245 and network 1250 for communicating with any number of networked components, devices, and systems, including one or more computer devices of the same or different configuration. Computer device 1605 or any connected computer device can be functioning as, providing services of, or referred to as a server, client, thin server, general machine, special-purpose machine, or another label.

IO interface 1625 can include but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 1600. Network 1250 can be any network or combination of networks (e.g., the Internet, local area network, wide area network, a telephonic network, a cellular network, satellite network, and the like).

Computer device 1605 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 1605 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1610 can execute under any operating system (OS) (not shown), in a native or virtual environment. One or more applications can be deployed that include logic unit 1660, application programming interface (API) unit 1665, input unit 1670, output unit 1675, and inter-unit communication mechanism 1695 for the different units to communicate with each other, with the OS, and with other applications (not shown). The described units and elements can be varied in design, function, configuration, or implementation and are not limited to the descriptions provided. Processor(s) 1610 can be in the form of hardware processors such as central processing units (CPUs) or in a combination of hardware and software units.

In some example implementations, when information or an execution instruction is received by API unit 1665, it may be communicated to one or more other units (e.g., logic unit 1660, input unit 1670, output unit 1675). In some instances, logic unit 1660 may be configured to control the information flow among the units and direct the services provided by API unit 1665, the input unit 1670, the output unit 1675, in some example implementations described above. For example, the flow of one or more processes or implementations may be controlled by logic unit 1660 alone or in conjunction with API unit 1665. The input unit 1670 may be configured to obtain input for the calculations described in the example implementations, and the output unit 1675 may be configured to provide an output based on the calculations described in example implementations.

Processor(s) 1610 can be configured to generate a draft proposal of a project as shown in FIG. 2. The processor(s) 1610 may also be configured to send the draft proposal to a client device to be reviewed by a client as shown in FIG. 2. The processor(s) 1610 may also be configured to receive a client input on the draft proposal from the client device as shown in FIG. 2. The processor(s) 1610 may also be configured to, for the client input indicating client approval of the draft proposal, initiate work scheduling with the client as shown in FIG. 2.

The processor(s) 1610 may also be configured to incrementing an iteration counter by a value of one as shown in FIG. 2. The processor(s) 1610 may also be configured to determining whether a value of the iteration counter is equal to an iteration threshold as shown in FIG. 2. The processor(s) 1610 may also be configured to, for the value of the iteration counter being determined as equal to the iteration threshold, terminating proposal drafting of the project as shown in FIG. 2.

The processor(s) 1610 may also be configured to, for the value of the iteration counter being determined as less than the iteration threshold, updating, by the processor, the draft proposal to generate an updated draft proposal of the project as shown in FIG. 2. The processor(s) 1610 may also be configured to sending the updated draft proposal to the client device to be reviewed by the client as shown in FIG. 2. The processor(s) 1610 may also be configured to receiving a second client input on the updated draft proposal from the client device as shown in FIG. 2. The processor(s) 1610 may also be configured to, for the second client input indicating client approval of the updated draft proposal, initiating work scheduling with the client as shown in FIG. 2.

The processor(s) 1610 may also be configured to incrementing the iteration counter by a value of one as shown in FIG. 2. The processor(s) 1610 may also be configured to determining whether the value of the iteration counter is equal to the iteration threshold as shown in FIG. 2. The processor(s) 1610 may also be configured to, for the value of the iteration counter being determined as equal to the iteration threshold, terminating, by the processor, proposal drafting of the project as shown in FIG. 2. The processor(s) 1610 may also be configured to, for the value of the iteration counter being determined as less than the iteration threshold, reinitiating update on the updated draft proposal for the client to review as shown in FIG. 2.

The processor(s) 1610 may also be configured to receive status updates on at least one task associated with the draft proposal after (i) receiving the client input indicating approval of the draft proposal; and (ii) the at least one task has been initiated as shown in FIG. 2. The processor(s) 1610 may also be configured to, for a completion status being received for at least one task, issuing an invoice associated with at least one task to the client as shown in FIG. 2. The processor(s) 1610 may also be configured to receive project information comprising of one or more of location information, project type, or image data as shown in FIG. 2.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for performing project management, the method comprising:
generating, by a processor, a draft proposal of a project;
sending, by the processor, the draft proposal to a client device to be reviewed by a client;
receiving, by the processor, a client input on the draft proposal from the client device; and
for the client input indicating client approval of the draft proposal, initiating, by the processor, work scheduling with the client.

2. The method of claim 1, further comprising:
for the client input indicating client rejection or modification of the draft proposal:
incrementing, by the processor, an iteration counter by a value of one;
determining, by the processor, whether a value of the iteration counter is equal to an iteration threshold; and
for the value of the iteration counter being determined as equal to the iteration threshold, terminating, by the processor, proposal drafting of the project.

3. The method of claim 2, further comprising:
for the value of the iteration counter being determined as less than the iteration threshold, updating, by the processor, the draft proposal to generate an updated draft proposal of the project;
sending, by the processor, the updated draft proposal to the client device to be reviewed by the client;
receiving, by the processor, a second client input on the updated draft proposal from the client device; and
for the second client input indicating client approval of the updated draft proposal, initiating, by the processor, work scheduling with the client.

4. The method of claim 3, further comprising:
for the second client input indicating client rejection or modification of the updated draft proposal:
incrementing, by the processor, the iteration counter by a value of one;
determining, by the processor, whether the value of the iteration counter is equal to the iteration threshold;
for the value of the iteration counter being determined as equal to the iteration threshold, terminating, by the processor, proposal drafting of the project; and
for the value of the iteration counter being determined as less than the iteration threshold, reinitiating update on the updated draft proposal for the client to review.

5. The method of claim 1, further comprising:
receiving, by the processor, status update on at least one task associated with the draft proposal after (i) receiving the client input indicating approval of the draft proposal; and (ii) the at least one task has been initiated.

6. The method of claim 5, further comprising:
for a completion status being received for the at least one task, issuing, by the processor, an invoice associated with the at least one task to the client.

7. The method of claim 1, further comprising:
receiving, by the processor, project information comprising one or more of location information, project type, or image data.

8. The method of claim 7,
wherein the generating the draft proposal is performed using an Artificial Intelligence (AI) model,
wherein the AI model receives project information as input and generates the draft proposal as output.

9. A non-transitory computer readable medium, storing instructions for performing project management, the instructions comprising:
generating a draft proposal of a project;
sending the draft proposal to a client device to be reviewed by a client;
receiving a client input on the draft proposal from the client device; and
for the client input indicating client approval of the draft proposal, initiating scheduling with the client.

10. The non-transitory computer readable medium of claim 9, further comprising:
for the client input indicating client rejection or modification of the draft proposal:
incrementing an iteration counter by a value of one;
determining whether a value of the iteration counter is equal to an iteration threshold; and
for the value of the iteration counter being determined as equal to the iteration threshold, terminating proposal drafting of the project.

11. The non-transitory computer readable medium of claim 10, further comprising:
for the value of the iteration counter being determined as less than the iteration threshold, updating the draft proposal to generate an updated draft proposal of the project;
sending the updated draft proposal to the client device to be reviewed by the client;
receiving a second client input on the updated draft proposal from the client device; and
for the second client input indicating client approval of the updated draft proposal, initiating work scheduling with the client.

12. The non-transitory computer readable medium of claim 11, further comprising:
for the second client input indicating client rejection or modification of the updated draft proposal:
incrementing the iteration counter by a value of one;
determining whether the value of the iteration counter is equal to the iteration threshold;
for the value of the iteration counter being determined as equal to the iteration threshold, terminating proposal drafting of the project; and
for the value of the iteration counter being determined as less than the iteration threshold, reinitiating update on the updated draft proposal for the client to review.

13. The non-transitory computer readable medium of claim 9, further comprising:
receiving status update on at least one task associated with the draft proposal after (i) receiving the client input indicating approval of the draft proposal; and (ii) the at least one task has been initiated.

14. The non-transitory computer readable medium of claim 13, further comprising:
for a completion status being received for the at least one task, issuing an invoice associated with the at least one task to the client.

15. The non-transitory computer readable medium of claim 9, further comprising:
receiving project information comprising one or more of location information, project type, or image data.

16. The non-transitory computer readable medium of claim 15,
wherein the generating the draft proposal is performed using an Artificial Intelligence (AI) model,
wherein the AI model receives project information as input and generates the draft proposal as output.
